(19) United States
(12) Patent Application Publication
(10) Pub. No.: US 2026/0341177 A1
(43) Pub. Date: Oct. 29, 2026

(54) Card decks and expansion packs and the method of making the same

(71) Applicant: TradeInvest HoldingsLtd., GIBRALTAR (GI)

(72) Inventor: Emma Jo Savona Ventura, Gharghur (MT)

(73) Assignee: TradeInvest HoldingsLtd., GIBRALTAR (GI)

(21) Appl. No.: 19/189,300

(22) Filed: Apr. 25, 2025

(51) Int. Cl. G09B 19/00; G06K 19/06

(52) U.S. Cl. CPC G09B 19/00; G06K 19/06037

(57) ABSTRACT

A deck of cards and expansion packs of cards with cues and longer explanations to help people with mental health, brain health, pregnancy anxieties, childbirth or even for children and young adults to help them build better mental fortitude. Each card in the decks or expansion decks will have a time-of-day mark indicating the best time of day to practice specific habits for maximum benefit to brain health. Each card will also have a QR code leading to a blog relevant to a specific card's topic giving more background. Cards and decks will be branded as per company branding or left plain to focus on content, and different manufacturing processes or finishings may be used. A companion app may also be released showing a digital copy of each deck and expansion pack. Different types of pouches may be available for discrete carrying of the cards or decks.

### BACKGROUND OF THE INVENTION

### 1. Field of the Invention

The present invention relates to card decks and expansion packs for bettering mental health, brain health, to deal with pregnancy anxieties, cope with childbirth and help children and young adults with building mental fortitude. These decks and expansion packs can be used during a mental health or brain health crisis, when pregnant, during childbirth or by children and young adults on a day-to-day basis.

The present invention is built on neuroscientific research and contains scientific content, not affirmations, mindfulness quotes, oracle cards or tarot cards.

### 2. Description of Related Art

In the publishing industry, significant effort has been expended toward developing card decks that provide people with affirmations and motivational quotes. However, these affirmation and motivational card decks have drawbacks. For instance, while affirmation or motivational card decks can lead to a more positive mindset, they do not tackle actual specific mental health or brain health issues a person may have. They also do not serve as a tether or quick reference during a mental health or brain health episode nor do they provide concrete mental health or brain health guidance during pregnancy or childbirth. Affirmation card decks have also been developed for children and young adults but fail to provide concrete guidance for good brain health habits.

Similarly, in the medical sector, significant effort is being made toward helping people with their mental health or brain health problems, and to give the best possible prenatal and postnatal care. Many different approaches have been taken towards this end, such as providing people with therapy or counselling, medication, lifestyle changes such as diet or supplementation, prenatal checkups, holding prenatal classes, postnatal checkups etc. However, all of these approaches have drawbacks. For instance, while some approaches just mask mental health and brain health symptoms and do not help people get to the root of the issue, others aim to give people the skills needed during a mental health or brain health episode but lack in giving persons anything tangible they can refer to during such an episode. The same is true for pregnancy and childbirth where persons have no easy brain health or mental health reference during pregnancy or childbirth. Children and young adults struggling with mental health are generally offered therapy and/or medication which is extremely beneficial for most, however there are no quick references to build mental fortitude and build healthy brain health foundations.

Affirmation and motivational decks contain positive content to trigger a positive mindset which is usually not enough during a mental health or brain health episode since persons have less mental clarity at this point in time. Affirmation and motivational decks may help during pregnancy and childbirth again since they trigger a positive mindset however even in these instances if the person is in a more distressed state the affirmation and motivational decks may have little to no effect. What would be needed at this point in time is short guides to follow that help ground the mind quickly with tangible tasks to perform, especially during childbirth. This is also true for children and young adults who struggle with brain health and where only affirmation decks are available to them. The content is all just a positive sentence to hopefully shift the brain into a more positive mindset, however, they do not give guidance regards methods and habits to build this brain health and mental fortitude on a daily basis.

Affirmation and motivational decks are also beautiful and pleasing to look at which may instill a sense of happiness and calm in a person, however this is usually not enough during a mental health or brain health episode, during a bout of pregnancy anxiety, during childbirth or for children or young adults struggling with brain health. Having a pleasing visual along with a short guide of action to further nudge the mind in a positive direction would be more useful.

It would be advantageous, therefore, to have a deck of cards that provides the advantages of being an easy reference during a mental health or brain health episode, or during pregnancy and childbirth by providing short, easy, clear and concise guides. Such a deck would also double as a daily reference to instill healthy mental health and brain health habits.

### SUMMARY OF THE INVENTION

The above needs are met and other advantages achieved by providing decks of cards and expansion packs for supporting people with their mental health, brain health, pregnancy anxieties, childbirth, and to help children and young adults to build mental fortitude. These can be used as an aid in a moment of crisis or day-to-day life. All embodiments of the present invention are not meant to replace seeking proper healthcare or medical advice. However, all embodiments of the present invention are meant to be used as a tool or aid to further help engrain the mental health and brain health teachings that persons may be receiving from their medical health professionals on a day-to-day basis. All embodiments of the current invention can also serve as a good reference and guide when persons are suffering from a mental health or brain health episode, a bout of pregnancy anxiety or during childbirth and are not thinking clearly.

In one embodiment, the deck of cards may focus on mental health or brain health guides. On the face of each card there will be a short easy to understand text, whilst on the back a deeper explanation of the text and the mental health or brain health concept behind it.

In another embodiment, the deck of cards may focus on pregnancy related mental health or brain health guides. On the face of each card there will be a short easy to understand text, whilst on the back a deeper explanation of the text and the mental health or brain health concept behind it.

In another embodiment, the deck of cards may focus on childbirth related guides. On the face of each card there will be a short easy to understand text, whilst on the back a deeper explanation of the text and the mental health or brain health concept behind it.

In another embodiment, the deck of cards focused on mental health and brain health may be simplified for children and young adults, to further help kids develop mental strength and fortitude. This can help children to grow up mentally strong and enable them to cope with challenges they face as they grow older, setting them up for a better future.

Each embodiment of the current invention, may be translated into different languages to reach a broader audience. Also, each embodiment of the current invention may be sized differently so as to make the deck of cards more discrete and therefore easier to carry around at work, school etc. without being noticed. This allows persons to reference the deck of cards or individual cards more discretely when a brain health challenge arises.

In another aspect, the deck of cards includes a time-of day indication to enable persons to use the cards as part of their daily routine to build stronger mental health and brain health habits. Some cards may be more beneficial to follow in the mornings, whilst others may be more beneficial to follow last thing at night before going to bed, hence why the cards are clearly indicated with a time-of-day logo. Each card may include a design or may be kept plain not to distract from the content. The cards may have different textures and may be printed on different types of paper and in different sizes amongst other printing methods or variations.

Further included in the invention may be a cover or pocket in which a person can hold the whole deck or a few favorite cards for discrete carrying around, and easy reference on the go.

Further included in the invention may be expansion packs for each embodiment of the current invention as mentioned in the points above. These expansion packs, like the present invention, may be translated into different languages, may be sized differently, may be printed on different types of paper and may use different printing methods or variations.

Further included in the invention may be a companion mobile app, which would provide a digital version of all the cards from all the decks and expansion packs of each embodiment of the current invention as described in the points above.

The card deck of the present invention has many advantages. For example, the time-of-day indication on each card helps people practice certain brain health exercises at the most opportune time of day when the brain may be most primed for that exercise. This time-of-day indication can also help people get into a brain health routine starting out with their favorite morning cards, followed by the day cards which may be chosen or used based on the current day's mental health need, and finally the night cards that help prepare peoples'brains to unwind and get ready for a restful sleep. The text content of all embodiments of the current invention will cover mental health, brain health, address pregnancy anxieties and childbirth and serves as an advantage for people to reference what they may learn from therapy or medical health professionals more easily even if they are struggling to focus or remember in the emotion of their present situation or predicament. The discrete pouches also serve as an advantage for people to be able to carry these cards or decks discretely without other people noticing. Many may still feel that self-help references such as these decks and cards can still be taboo, especially in the workplace therefore such pouches serve as a great advantage for people to be able to discretely carry the decks or card say for example to the bathroom for reference. The advantage of having the physical deck as opposed to the app is that the tactile feeling of each card can also help to ground persons in a time of a brain health, mental health or anxiety situation.

### BRIEF DESCRIPTION OF DRAWINGS

Having thus described the invention in general terms, reference will now be made to the accompanying drawings, which are not necessarily drawn to scale, and wherein:

FIG. 1 is a front view of a card a.k.a. the face of the card of one embodiment of the present invention;

FIG. 2 is a rear view of the card of FIG. 1, and is also one embodiment of the present invention;

FIG. 3 is a whole deck of cards as described in FIG. 1 and FIG. 2 and is also one embodiment of the present invention;

FIG. 4 is an expansion pack of cards as described in FIG. 1 and FIG. 2. This is also one embodiment of the present invention;

### DETAILED DESCRIPTION OF THE INVENTION

The present invention now will be described more fully hereinafter with reference to the accompanying drawings where applicable, in which some but not all embodiments of the invention are shown. Indeed, this invention may be embodied in many different forms and should not be construed as limited to the embodiment set forth herein; rather, these embodiments are provided so that this disclosure will satisfy applicable legal requirements. Like numbers refer to like elements throughout.

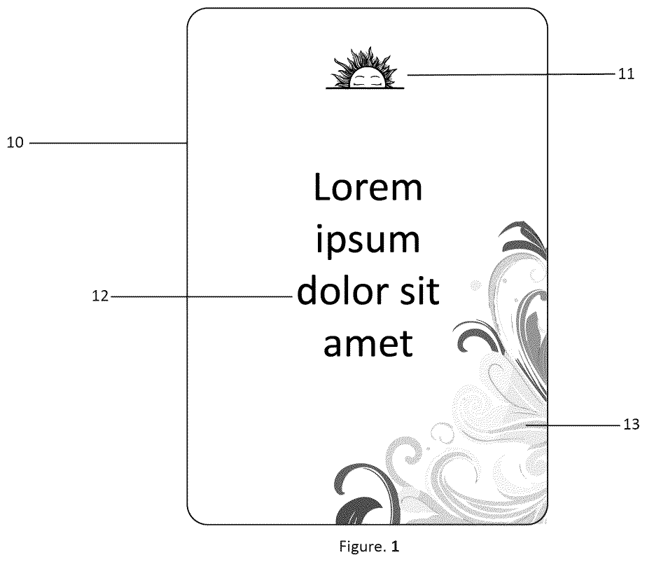

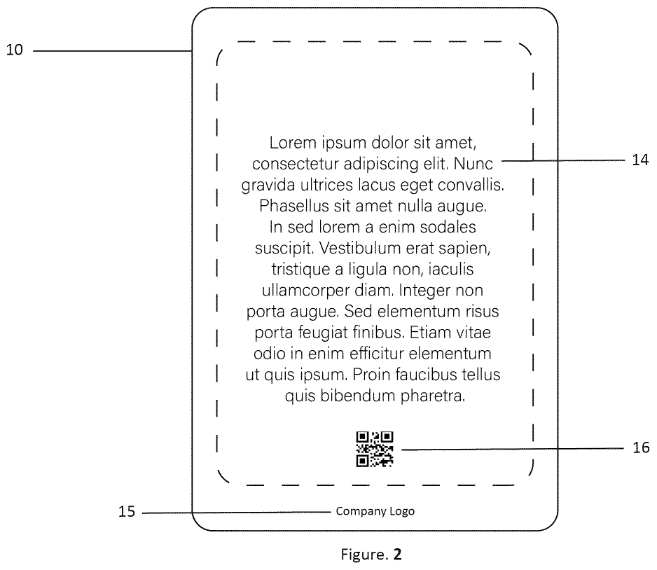

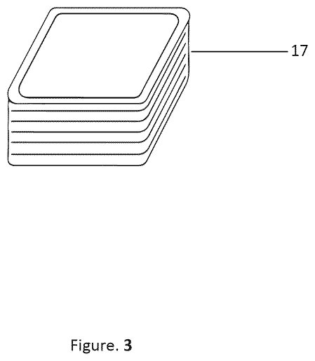

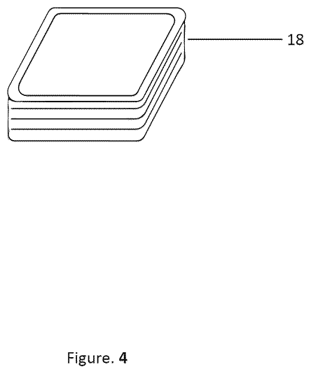

A card deck 17 or expansion pack of cards 18 and a method for constructing the decks in accordance with one preferred embodiment of the invention are illustrated in FIGS. 1-4. The deck of cards 17 and expansion pack of cards 18 will consist of an undefined number of cards 10. Each card 10 will have a face as shown in FIG. 1 and a back as shown in FIG. 2. The face of card 10 will contain a time-of-day indication 11, and a simplified cue 12 that serves as a quick mental health guide, brain health guide, pregnancy guide or childbirth guide. The face of the card 10 may also have the design 13 or lack the design 13. The back of the card 10 will contain a more detailed explanation 14 of the above-mentioned simplified cue 12 found on the face of the same card. The company logo 15 will also be visible on the back of the card as-well-as a QR code 16 that links to a blog website for more information on 12 and 14 of each relevant card.

The deck of cards 17 or expansion pack of cards 18 may be manufactured from different types of paper or printing materials, use different paper weights, different finishing for example glossy, matte, natural uncoated, kraft, textured uncoated, soft touch, recycled or any other configuration of paper and finishing.

In another aspect, the deck of cards 17 or expansion packs 18 may also be manufactured with cards 10 having different textures i.e. they can either have a smooth texture or have more coarse textures that have been found to help persons ground themselves using the sense of touch.

Advantageously, the deck of cards 17 or expansion packs 18 will be available in multiple languages allowing the decks and expansion packs to reach a broader audience and therefore help more people.

The deck of cards 17 or expansion packs 18 will also be made available in different sizes to be able to be carried more easily in their own packaging or in other pouches that will be designed specifically to conceal the deck, expansion packs or cards for discrete carrying.

Content 11 is the time-of-day logo and represents the time of day in which acting on the particular cue 12 would have most impact and benefit on a person's mental health or brain health. Each card 10 and its corresponding cue 12 can be used at any time of day depending on the need, however element 11 also serves a guide for whoever wants to use the cards throughout the day at the suggested times to get into the best mental and brain health routine. Content 11 will be printed on the face of the card 10.

Content 12 is the short and easy to understand text as a cue or guide related to mental health, brain health, pregnancy, childbirth, or for children and young adults. Content 12 serves as a short easy instruction and will usually be the first element persons would reference on the cards 10. Content 12 will be printed on the face of the card 10.

Content 13 is the artwork or design which may or may not be printed on the cards 10. The artwork or design shown in FIG. 1 is not an actual representation of the actual artworks or designs which will be printed on the cards 10. If content 13 is not included on the cards 10, this would mean that the cards will be left plain to avoid distraction from the main content 12. Content 13 will be printed on the face of the card 10.

Content 14 is a more detailed explanation of content 12 and will elaborate more on what the guideline or cue 12 means from a scientific, brain health and mental health perspective. Content 14 will be printed on the back of the card 10.

Content 15 is the company logo. Content 15 will be printed on the back of the card 10.

Content 16 is the QR code linking each card 10 to the relevant webpage which will give more information about content 12 and 14 printed on each card. Content 16 will be printed on the back of the card 10.

The present invention can be combined with discrete pouches and packaging that the deck of cards 17 and expansion packs of cards 18 can be carried around in discretely. This is also one embodiment of the present invention;

The present invention can have a companion app showing a digital version of all the cards found in the deck 17 and cards found in expansion packs of cards 18. This is also one embodiment of the present invention.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A deck of cards for supporting mental health, brain health, ease pregnancy anxieties, as
a childbirth aid or to help children and young adults build mental fortitude, comprising:
an undefined, unfixed or flexible number of cards in each deck;
a time-of-day indication, a short text, a design, a longer text, company logos, and a QR code;
said time-of day indication in the form of a logo on the face of the card representing morning, day and evening;
said short text on the face of the card written as a short, easy to understand, simple and quick cue or guideline;
said design on the face of the card which serves to give the cards a good appearance and make them more attractive. This may or may not be included on the cards i.e. cards may also be left plain;
said longer text on the back of the card giving a deeper explanation on the short text found on the face of the card as mentioned above;
said company logos on the back of the card representing the company and company branding;
said QR code on the back of the card directing persons to a blog related to the same topic as the specific card.

2. A deck of cards of claim 1, comprising of an undefined, unfixed or flexible number of cards i.e. mental health, brain health, pregnancy, childbirth, and children and young adult decks may be comprised of a different number of cards.

3. A deck of cards of claim 1, with a time-of-day indication suggesting the best time of day to use the particular card. This is merely a suggestive indication in case persons want to use different cards during the day at the most opportune times for better brain health. The cards can be used at any time of day and this time-of-day indication can be ignored.

4. A deck of cards of claim 1, with a short mental health, brain health, pregnancy, childbirth, or children and young adult cue or guideline on the face of the card that is short and easy to understand and action. This cue or guideline serves to help ground a person quickly into action.

5. A deck of cards of claim 1, with a design or artwork making the cards more appealing, attractive and also instill a sense of happiness in persons using the cards.

6. A deck of cards of claim 5, without a design or artwork making the cards plainer for persons to focus more on content of the cards.

7. A deck of cards of claim 1, with a longer mental health, brain health, pregnancy, childbirth, or children and young adult cue or guideline on the back of the card. This longer text serves to give persons more context regards the short cue given on the face of the card and also gives the ability to understand more deeply the science behind the cue or action indicated on the face of the card.

8. A deck of cards of claim 1, showing the company logo at the back of the card. This serves to keep the cards within branding guidelines.

9. A deck of cards of claim 1, with a unique QR code on the back of each card in the deck. Each QR code directs persons to a blog giving more information and background about the topic a specific card is hitting on.

10. A deck of cards of claim 1, printed in different languages to reach a broader audience and help as many people as possible.

11. A deck of cards of claim 1, printed in different sizes for the cards and decks to remain a comfortable size to carry around and so that they also remain discrete.

12. A deck of cards of claim 1, printed on different materials such as different quality paper and with different finishing such as for example matte, gloss, including a gold trim and any other combination of printing and finishing methods available.

13. An expansion deck of cards for supporting mental health, brain health, ease pregnancy anxieties, as a childbirth aid or to help children and young adults build mental fortitude, comprising:
an undefined, unfixed or flexible number of cards in each expansion deck;
a time-of-day indication, a short text, a design, a longer text, company logos, and a QR code;
said time-of day indication in the form of a logo on the face of the card representing morning, day and evening;
said short text on the face of the card written as a short, easy to understand, simple and quick cue or guideline;
said design on the face of the card which serves to give the cards a good appearance and make them more attractive. This may or may not be included on the cards i.e. cards may also be left plain;
said longer text on the back of the card giving a deeper explanation on the short text found on the face of the card as mentioned above;
said company logos on the back of the card representing the company and company branding;
said QR code on the back of the card directing persons to a blog related to the same topic as the specific card.

14. An expansion deck of cards of claim 10, comprising of an undefined, unfixed or flexible number of cards i.e. mental health, brain health, pregnancy, childbirth, or children and young adult expansion decks may be comprised of a different number of cards.

15. An expansion deck of cards of claim 10, with a time-of-day indication suggesting the best time of day to use the particular card. This is merely a suggestive indication in case persons want to use different cards during the day at the most opportune times for better brain health. The cards can be used at any time of day and this time-of-day indication can be ignored.

16. An expansion deck of cards of claim 10, with a short mental health or brain health cue or guideline on the face of the card that is short and easy to understand and action. This cue or guideline serves to help ground a person quickly into action.

17. An expansion deck of cards of claim 10, with a design or artwork making the cards more appealing, attractive and also instill a sense of happiness in persons using the cards.

18. An expansion deck of cards of claim 14, without a design or artwork making the cards plainer for persons to focus more on content of the cards.

19. An expansion deck of cards of claim 10, with a longer mental health, brain health, pregnancy, childbirth, or children and young adult cue or guideline on the back of the card. This longer text serves to give persons more context regards the short cue given on the face of the card and also gives the ability to understand more deeply the science behind the cue or action indicated on the face of the card.

20. An expansion deck of cards of claim 1, showing the company logo at the back of the card. This serves to keep the cards within branding guidelines.

21. An expansion deck of cards of claim 1, with a unique QR code on the back of each card in the deck. Each QR code directs persons to a blog giving more information and background about the topic a specific card is hitting on.

22. An expansion deck of cards of claim 10, printed in different languages to reach a broader audience and help as many people as possible.

23. An expansion deck of cards of claim 10, printed in different sizes for the cards and decks to remain a comfortable size to carry around and so that they also remain discrete.

24. An expansion deck of cards of claim 10, printed on different materials such as different quality paper and with different finishing such as for example matte, gloss, including a gold trim and any other combination of printing and finishing methods available.

25. A carry pouch for discrete carrying of the expansion deck of cards of claim 10 that look like and mimic other types of pouches to allow for discrete carrying of the decks and cards. For example, pouches that look like wallets or pouches that look like a small makeup bag.

26. A mobile app providing a digital copy of the cards in the expansion packs of claim 10 providing also a copy on one's devices.
